(19) United States
(12) Patent Application Publication
(10) Pub. No.: US 2005/0102251 A1
(43) Pub. Date: May 12, 2005

(54) Method of document searching

(76) Inventor: David Gillespie, Cannon Hill (AU)

Correspondence Address: Edwin D Schindler, Five Hirsch Avenue, PO Box 966, Coram, NY, 11727-0966, US

(21) Appl. No.: 10/451,188

(22) PCT Filed: Dec. 14, 2001
(86) PCT No.: PCT/AU01/01618

(30) Foreign Application Priority Data
Dec. 15, 2000 (AU) PR 2080

(51) Int. Cl. G06F 7/00

(52) U.S. Cl. 707/1

(57) ABSTRACT

A method for searching documents, which uses a concept based retrieval methodology, uses for any query an adaptive self-generating neural network for analyzing concepts contained in the documents being searched as such concepts occur. The method automatically creates, abstracts and populates categories of concepts for each query, and is not restricted to language, but can also be applied to non-text data, such as voice, music, image and film. The method is able to deliver search results that are relevant to the query and to the context of the query and, therefore, arranges results by concept, rather than keyword occurrence.

### AREA OF THE INVENTION

This invention relates to a method of searching documents efficiently and in particular to a method for searching documents for relevance in a computer based environment.

### BACKGROUND TO THE INVENTION

IT managers today are increasingly faced with the problem of intelligently storing and accessing the massive amounts of data their organizations generate internally as well as that which originates from external sources. Content volume is growing at an exponential rate for corporate data systems such as the intranet as well as the Internet and current search technologies are not capable of effectively coping with this increase.

### SUMMARY OF CURRENT SEARCH TECHNOLOGIES

All modern search engines are based on Keyword indexing technology. A keyword engine creates an index of the material to be searched in much the same fashion as the Index to a book. However as you increase the size of the data set to which you apply this method, result sets become unwieldy. This is simply a function of the fact that the English language contains only 400,000 words and less than 100,000 are in common usage.

The keyword index approach becomes more and more unusable as the amount of content increases, simply because the list of references are returned with no particular ordering and the number of references in the list will naturally increase. Therefore some form of ranking of the results is preferred so that less time can be spent examining the set.

Relevancy formulas were introduced which determined that a document was more ‘relevant’ based on the frequency of occurrence of the search term in the document. Another variation that has gained popularity during recent times is Bayesian or probabilistic methods.

Bayesian logic measures the occurrence of the search terms in a given document relative to their occurrence in the overall document set being searched. For a document to be ‘relevant’ using Bayesian logic it must not only have a large number of hits on the word or phrase being searched, it must also have more occurrences than the rest of the document set.

This type of logic works well for experts searching a set of similar documents such as a lawyer searching a case database but would have no detectable advantage for a more general or mixed document set. Browsing by category was then considered a potential answer.

Browsing allows a user to navigate the indexed document set using a pre-defined taxonomy of keywords. Documents are grouped (or clustered) according to the keywords. This involves people manually classifying internet documents by saying which of the keyword categories apply to the document.

Manual categorization is however inherently non-scalable. Because of the exponential growth rate of information too many people are required to handle the information needed to be categorized. More recently, some companies have begun marketing technology that can automatically categorize the documents in the set. These systems typically work as follows:
1. A Category list (Taxonomy) is manually created. The Taxonomy contains groupings or topics under which the organization normally groups documents.
2. A set of documents that is considered representative of all documents in the organization is gathered (the larger the better)
3. The documents are then manually placed into categories. A neural network is shown the manual categorization and is able to establish the pattern of allocation of documents to categories. This is called ‘training the neural network’. The larger the document set that is manually categorized and the more representative it is of the organization's documents, the better this ‘training’ will be.
4. Thereafter as new documents are added they can be categorized according to the ‘rules’ established in the automatic training phase. This is often referred to as auto-categorization.

There are two major limitations with this form of categorization. If documents are encountered which do not fit within the existing categories then this technology will either assign it to the wrong category or refuse to assign it at all. If it is not categorized then a new category has to be manually created and the training phase repeated. Altering a corporate Taxonomy in most organizations is not a trivial task. Quite often a committee of Business Unit representatives who are not easily reconvened creates them. Most enterprises of any size would not be prepared to continuously review their taxonomy.

Much more seriously, the content being indexed (i.e. the data) is provided with context by the Taxonomy. If as is usually the case, the user is not familiar with the rules, which went into the creation of the Taxonomy, in the first place then they are extremely unlikely to be able to browse it effectively.

The electronic equivalent of this index is known as a Concept Tree. Unfortunately general-purpose concept trees are of little use to organizations trying to work within the confines of industry specific language and it is a prohibitive task to create and maintain ones own.

Language and context are extremely fluid notions that vary from individual to individual and from Business Unit to Business Unit. Any attempt to codify it is doomed to failure.

Even if all of these difficulties are overcome and a usable Taxonomy is available for the document set with as much of the user's context as is possible, there is still the problem of merging results from data sets with different Taxonomies or no Taxonomy. It is not possible to do this at all, so the Taxonomy is dropped in that circumstance and the user loses any advantage the user may have gained from the Taxonomy in the first place.

If a user types a keyword or phrase into the search interface of a browsable engine that matches a predetermined category in the Taxonomy, they will be presented with the predetermined result set which should return documents which are apparently related to the search but do not necessarily contain the search term. Because of this capability these engines are often marketed as concept search engines.

All of the methods described above are workarounds to the inherently non-scalable nature of Keyword indexes. These methods may work well for a few hundred thousand documents with a user familiar with the context (i.e. the reader of a book). Over the last 2 decades however as content growth has started an incremental climb up an exponential curve, layer after layer of workaround has been added just to try and keep pace. The rapacious growth in content has outstripped the ability of the technology to retrieve it even with the best Kludge's available.

It is not that keyword engines are worse now than they were 5 years ago, if anything they are far better. All of the improvements discussed above have contributed to more and more accurate Keyword searching. The problem lies in the fact that no matter how good they have become, by their very nature, Keyword engines will always return a certain fixed percentage of the data set being searched. The dataset being searched and hence the result set returned is in most cases increasing exponentially. Unfortunately for Keyword engines. a person's ability to cope with a result set is the same today as it was 1, 5 or 15 years ago. In the emerging information centric economy of the future users will not accept or tolerate technology that requires a significant manual effort to overcome an inherit limitation of the technology.

### OUTLINE OF THE INVENTION

It is an object of this invention to provide a search methodology which does not depend on creating long lists of word occurrences and then trying to massage that list into something sensible to a user.

The invention concerns a search methodology for documents, which is a concept based retrieval methodology, which for any query uses an adaptive self generating neural network to analyze concepts contained in the documents as they occur and automatically creates, abstracts and populates categories of concepts for each query, it is not restricted to language and can be applied to non-text data such as voice, music, image and film and is able to deliver search results that are relevant to the query and the context of the query and arranged by concept rather than keyword occurrence.

The invention is a search methodology for identifying concepts both in a natural language query and in an unstructured data collection which includes the steps of
matching the concepts in the query to those in the data to locate relevant items in the collection and
clustering the items together into groups where the member items are conceptually related.

It is preferred that two main processes are involved in information retrieval for unstructured data and that these processes are indexing and search.

It is further preferred that four elements are used in the search methodology to facilitate retrieval, these elements being natural language processing, feature extraction, self generating neural networks and data clustering.

It is also preferred that the indexing process involves identifying concepts and constructing an abstract for each item belonging to the unstructured data collection and organizing the items in a manner conducive to concept matching during the search process using the self generating neural network and that the search process employs natural language processing, the self generating neural network and clustering.

It is preferred that a query is parsed using the natural language processing element and submitted to the self generating neural network, which matches the concepts in the query to the items in the collection. A ranked set of items is then passed from the self generating neural network to the clusterer, which identifies common terms from the items' properties such that items which have similar properties are grouped together to form a cluster of items.

It is preferred that a label is generated for each cluster that represents a property common to all items in the cluster. The clusters and the items belonging to each can then be presented to the user, which concludes the search process.

In order that the invention may be more readily understood we will describe by way of non limiting example a specific embodiment of the invention with reference to the accompanying drawings.

### BRIEF DESCRIPTION OF THE DRAWING FIGURES

FIG. 1 shows an example of several documents and a query in 2 dimensional keyspace;

FIG. 2 shows a diagram of a self generating neural network of the invention organised as a tree;

### DESCRIPTION OF AN EMBODIMENT OF THE INVENTION

The methodology of the invention is used in addition to, not instead of, Keyword searching and its aim is to deliver the correct answer in the top 10 answers regardless of the size or origin of the result set.

The search methodology of the invention breaks down a search request into concepts (rather than keywords). It then looks for concepts that are similar to the concepts contained in the question. The result titles and abstracts that are returned by the search query are interpreted and analyzed by the search methodology to find Categories which best describe the results. This is done dynamically without the need to manually categorize the information at the time of indexing.

For convenience sake we will describe here an embodiment of the methodology of the invention using the name Darwin. Darwin facilitates conceptual searches on unstructured data. A conceptual search is a ‘query’ in the form of a question or topic, presented using the rich features of a spoken language with the intent of exploring a general idea. Unstructured data is a collection of information that, in its native form, lacks an inherent ‘schema’ or uniformity that allows one item in the collection to be classified and distinguished effectively from another.

The Darwin methodology is a means of i) Identifying concepts both in ‘natural language’ queries and in unstructured data, ii) Matching the concepts in the query to those in the data to locate relevant items in the collection and iii) Clustering the resulting items together into groups where the member items are conceptually related.

The two main processes involved in Information Retrieval (IR) for unstructured data are indexing and search. In Darwin, four elements of the technology are used to facilitate retrieval: Natural Language Processing (NLP); Feature Extraction; Self Generating Neural Networks (SGNN) and Data Clustering. The indexing process employs feature extraction and the SGNN. The search process employs NLP, the SGNN and clustering.

Whilst some of the abovementioned elements can be found in existing retrieval technology, the implementation of each element and the combination of elements used in both the indexing and search process are unique to Darwin.

The indexing process involves identifying concepts and constructing an abstract for each item belonging to the unstructured data collection (Feature Extraction) and organizing the items in a manner (SGNN) conducive to concept matching during the search process.

During search, the query is parsed using the NLP element and submitted to the SGNN, which matches the concepts in the query to the items in the collection. A ranked set of items is then passed from the SGNN to the clusterer, which identifies common terms from the items' properties. Items which have similar properties are grouped together to form a cluster of items. A label is generated for each cluster that represents a property common to all items in the cluster. The clusters and the items belonging to each can then be presented to the user, which concludes the search process.

The element of the Darwin technology that involves identifying concepts in an item begins by parsing the item into a collection of phrases, where phrase delimiters are defined by the syntactical rules of the language in which the document is written. The rules for implementation in the English language are unique to Darwin. This parsing process also removes case dependencies (No distinction is drawn between ‘Bank’ and ‘bank’) as well as eliminating various characters in the phrase deemed to be insignificant or unlikely query candidates (e.g. ‘#$%\hat{ }’).

When the phrases for an item have been identified, each phrase is examined from left to right for the words and ‘ngrams’ within the phrase. An ngram is a sequence of characters, typically 3 to 6 in length, where the length remains fixed for all items in a collection. Ngrams in a phrase are identified by locating an imaginary ‘Window’ over the leftmost ‘N’ characters in a phrase. The sequence of characters in the window is recorded and the window moves one character to the right in the phrase until the rightmost position of the window falls on the rightmost character in the phrase. Each successive ngram is recorded for an item. As each word and ngram in the phrase is found, a frequency distribution of unique words and ngrams is built to form a ‘Foreground’ representing the item.

As each item is parsed, the frequency distributions from the foreeground also added to a ‘Background’ to form the cumulative frequency distribution of all words and ngrams in the unstructured collection of items.

When the background has been compiled, a ‘Novelty’ score is then calculated for each ngram in each item. Ngrams and words that appear frequently in an item but infrequently in the background attract high scores, but ngrams and words that appear frequently in both the item and the background have a reduced score because the ngram or term is not deemed ‘Novel’ relative to the collection as a whole.

The score for each unique ngram in an item is then distributed amongst each character in the ngram. The distribution is non-linear, assigning a greater percentage of the score for the ngram to the characters in the mid-point of the ngram. For example, if the score of the ngram ‘lowly’ is 10, the score attributable to each character could be 1, 2, 5, 2 and 1 respectively.

A score for each character in each phrase for an item is then calculated. Starting with the leftmost character in the phrase, each ngram that includes the character in the phrase is obtained. For example, in the following text:

john
ohn s
hn sl
n slo
   slow
   slowl
   lowly
      owly
      wly r
      ly ro
      y ros
         rose

For the character ‘y’, the five ngrams in bold would be used in scoring the character. Only the score attributable from the ‘y’ of each ngram are used.

Abstracts for an item are constructed from a collection of the highest scoring phrases concatenated together. The score for a phrase is the average character weight for the phrase with a logarithmic function applied to the phrase length to give preference to longer phrases.

In a phrase, the score for each word is the average character weight for for the word. The scores for each occurance of a word in an item are averaged for the frequency of the item. A threshold is applied to all words in an item to eliminate insignificant words.

If no significant words are found in an item, the same novelty calculation used for ngrams is used for the words in an item and the most significant words are retained.

Using either the ngram or word based approaches for identifying significant words, a ‘Stop List’ is used to eliminate insignificant words such as ‘The’ and ‘And’. The Porter word stemming algorithm is then applied to the remaining words to reduce all morphological variants of words to their root form.

Identification of significant words within phrases of an item in a collection completes the feature extraction process during indexing. These words, along with other metadata in the document such as the title, document name or manually generated keywords, are then stored for the item using the SGNN.

The SGNN represents both items in a collection and queries as vectors. Items are characterized by a list of keys and their corresponding weights. Keys are synonomous to words from the feature extraction stage as weights are to scores. The (key, weight) pairs are produced by the feature extractor.

The item characteristic may be represented by a K-dimension vector where K is the number of distinct keys present in the item collection or corpus. Keys that are not present in a given items's characteristic are assigned a weight of zero.

A query is also characterized by a list of keys and their corresponding weights. The (key, weight) pairs are produced by the natural language element. This is described later in this document, but essentially a key may be understood to be a query term and its weight may be understood to represent the relative importance of the term within the query, as determined by syntactic and lexical analysis. Keys that are not present in the corpus are ignored.

A query may also be represented by a K-dimension vector, where K is the number of distinct keys present in the corpus. Keys that are not present in the query are assigned a weight of zero.

With the given vector representations, each item and query maps to a single point in the K-dimension keyspace. Training the index is the process of building a searchable collection of item vectors; searching is the process of locating points in the keyspace that represent items and which are nearby the point specified by the query vector.

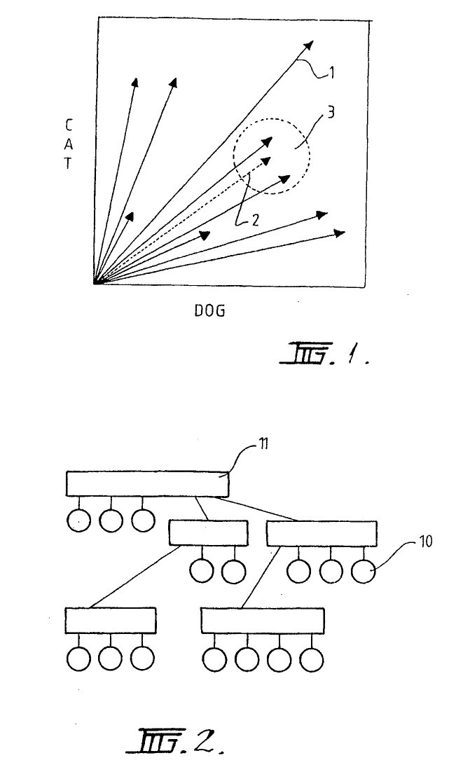

FIG. 1 shows several documents and a query in a 2-dimensional keyspace. The keyspace represents a corpus in which each document has only two unique terms—CAT and DOG. The solid black arrows 1 show document vectors. The dashed line 2 represents a query vector. The circle 3 highlights that part of the keyspace that is nearby the query. The two items that fall within this region form the result set for the query.

Obviously, real world item collections contain many more than two unique terms; usually tens or even hundreds of thousands. This implies that very large vector spaces need to be represented and searched efficiently. This is not a trivial problem. The SGNN provides a very efficient method to achieve this.

The SGNN bears some similarity to Kohonen's Learning Vector Quantization Nets (LVQ) but in the taxonomy of neural architectures is more closely related to the Competitive Neural Tree (CNeT). Like both of these structures, it is self learning and partitions example vectors into a number of subsets of ‘nearby’ vectors.

Both LVQ and CNeT, however, are primarily intended for classification. The network undergoes a training phase after which its learning rate is slowed or frozen. The trained network represents a set of categories and a process to decide to which category a given sample belongs.

In contrast, the SGNN is primarily intended for searching. There is no distinct training phase—the network is continuously trained as new items are added. Example vectors (representing items) are partitioned into subsets (categories) because this partitioning partitions the search space, which in turn produces excellent search performance. The SGNN is an indexing mechanism that adaptively selects efficient index terms to search large, sparse, arbitrary dimension vector spaces.

The SGNN nodes are organized as a tree as shown in FIG. 2. Leaf nodes 10 represent individual items; internal nodes 11 represent categories. Each node holds pointers to maintain the tree structure and a vector that represents the node's value or position in the vector space. A sparse vector representation is employed to reduce memory requirements and calculation time. Leaf nodes also hold a reference to the document that they represent.

The vectors in the leaf nodes are the (key, weight) terms for the item. These do not change. The vectors in the intermediate nodes represent an ‘average’ value for their sub-tree—they are exemplars for the documents in the sub-tree. The intermediate node vectors are adjusted as new documents are added. This process is known as training the network.

When a new example vector (Item) is presented to the net, nodes at each successive level of the tree ‘compete’ for it. The Euclidean distance between the sample vector and the node vector is calculated and nodes that are sufficiently similar are explored in greater depth. These nodes are known as ‘winners’ for the example. (This is similar to activation in conventional neural network parlance.) If a winning node has no children more similar to the example than itself, searching stops along that path, otherwise the search proceeds iteratively for winning children. The final winner is the node that is closest to the example.

If the final winner is an internal node, a new leaf is created for that node. If the winner is a leaf, a new internal node is created with the new node and the winning node as its children. Finally, all vectors in the nodes along the winning node's search path (which represent ‘averages’ of their descendant nodes) are updated to take account of the example vector.

Searching a conventional LVQ net involves finding the single category that is the best fit for a given sample. During search, the same distance measurement as was used for training is employed—searching is symmetric with training.

Searching the SGNN involves finding all vectors (items) that are sufficiently close (similar) to a given sample (query), not just the best—the search must deploy a wider net. To this end, the SGNN search employs a similarity measurement that is mathematically related to the distance measurement used in training, but less constrained. This is used both as an initial relevance score and as a steering heuristic to guide network traversal—searching is not symmetric with training.

Otherwise, the process used to search the network is similar to training—nodes (items) that are sufficiently similar to the sample (query) are explored in greater depth. A similarity ordered list of winning leaf nodes (internal nodes do not represent items) is maintained and this forms the result set for the query.

Ranking is the process whereby the items in the result set are ordered by their relevance to the query. This is carried out by calculating a score based upon matches between the query and the items's title and combining this with the similarity measurement (calculated during the SGNN search) to produce a final score upon which the result set is ordered.

The ranked result set is the output of the SGNN search—this is passed to the clustering engine.

The result categories presented will be different for every query and can change constantly in response to changes in the document set. Documents are not hardwired to respond to a particular keyword or phrase and can appear in multiple categories simultaneously. Darwin therefore interrogates the document set without regard to a preset context derived from an artificial taxonomy. Darwin's context is gained from the user's query. The results are arranged according to concepts contained in the user's query not according to predefined category trees. In this respect alone, Darwin is absolutely unique amongst retrieval software.

Darwin is the only technology capable of delivering accuracy across large diverse collections and small focused collections alike. Darwin delivers a browseable taxonomy with no human intervention as well as accurate and flexible clustering to that Taxonomy regardless of how the collection grows.

The search methodology of the invention uses a combination of intelligent processes to assist the user in finding the most relevant information that will satisfy their query. It is in fact a family of methodologies as previously described that encompasses concept based indexing for applications and addresses the functional areas of data retrieval, concept based indexing (Adaptive Self Generating Neural Network), natural language query processing, searching and clustering.

Whilst we have described herein one specific embodiment of the invention it is to be understood that variations in the implementation of the concept of the invention will still be considered as lying within the scope of the invention.

1-12. (canceled)

13. A method for searching documents by identifying concepts in both a natural language query and in an unstructured data collection, said method comprising the steps of:
matching concepts in a query to concepts in data for locating relevant items in a collection being searched; and,
clustering the relevant items together into groups wherein members of each group of said groups are conceptually related.

14. The method for searching documents according to claim 13, wherein information retrieval for unstructured data is carried out by an indexing step and a searching step.

15. The method for searching documents according to claim 14, wherein said information retrieval for unstructured data by elements comprising natural language processing, feature extraction, self-generating neural networks and data-clustering.

16. The method for searching documents according to claim 14, further comprising feature extracting wherein said indexing step identifies concepts and constructs an abstract for each item belonging to a collection of said unstructured data.

17. The method for searching documents according to claim 16, wherein said indexing step comprises the step of:
organizing each said item in a manner conductive for concept matching using a self-generating neural network.

18. The method for searching documents according to claim 13, wherein said matching step and said clustering step utilize natural language process, a self-generating neural network and data clustering.

19. The method for searching documents according to claim 13, wherein said matching step includes the steps of:
parsing said query using a natural language processing element;
submitting said query to a self-generating neural network for matching the concepts in said query to said relevant items in said collection; and,
passing a ranked set of items from said self-generating neural network to a data cluster.

20. The method for searching documents according to claim 19, wherein said data cluster identifies common items from properties of said relevant items, so that said relevant items having similar properties are grouped together for forming a cluster of items.

21. The method for searching documents according to claim 20, further comprising the step of:
generating a label for each said cluster of items representing a property common to all said relevant items in said cluster of items, so that said cluster of items and said relevant items belonging to each said cluster of items are presentable to a user when said method for switching documents is concluded.

22. The method for searching documents according to claim 13, wherein said matching step is performed for non-text material.
